(19) United States
(12) Patent Application Publication
(10) Pub. No.: US 2008/0009055 A1
(43) Pub. Date: Jan. 10, 2008

(54) Integrated photobioreactor-based pollution mitigation and oil extraction processes and systems

(75) Inventor: John J. Lewnard, Westford, MA (US)

Correspondence Address: WOLF GREENFIELD & SACKS, P.C., 600 ATLANTIC AVENUE, BOSTON, MA, 02210-2206, US

(73) Assignee: Greenfuel Technologies Corp., Cambridge, MA (US)

(21) Appl. No.: 11/656,330

(22) Filed: Jan. 22, 2007

Related U.S. Application Data
(60) Provisional application No. 60/819,981, filed on Jul. 10, 2006.
(60) Provisional application No. 60/819,976, filed on Jul. 10, 2006.

(51) Int. Cl. C02F 3/34; C02F 11/02

(52) U.S. Cl. 435/262; 435/292.1

(57) ABSTRACT

Integrated systems including a photobioreactor system designed to contain a liquid medium comprising at least one species of phototrophic organism therein, and a facility associated with extracting and/or processing oil extracted from mixtures of oil and solid material, such as an oil sands facility, are described. Processes for using a photobioreactor system as part of a gas-treatment process and system able to at least partially remove certain undesirable pollutants from a byproduct gas stream produced by an oil sands facility are also described. Examples of such pollutants that may be removed include compounds contained within combustion gases, e.g., CO₂ and/or NOₓ. These pollutants processed with the photobioreactor system, and, in some embodiments, biomass produced with the photobioreactor system may be utilized to produce a fuel source (e.g., biodiesel) and cutting stock for further operation of or use in the oil sands facility. Such uses of certain embodiments can provide an efficient means for recycling carbon, thereby reducing CO₂ emissions, fuel, and/or cutting stock requirements for a given quantum of energy produced. In addition, in some cases the photobioreactor can be integrated with a holding pond and waste heat from the oil extraction process can be used to maintain the photobioreactor temperature and/or provide energy for other processes. Accordingly, embodiments described herein can improve the overall environmental and economic profile of the oil sands facility.

### RELATED APPLICATIONS

This application claims priority under 35 U.S.C. §119(e) to U.S. Provisional Patent Application No. 60/819,981, filed Jul. 10, 2006, and entitled “Integrated Photobioreactor-Based Pollution Mitigation and Oil Extraction Processes and Systems,” and U.S. Provisional Patent Application No. 60/819,976, filed Jul. 10, 2006, and entitled “Photobioreactor Systems and Methods for Treating CO₂-Enriched Gas and Producing Biomass,” both of which are incorporated herein by reference in their entirety.

### FIELD OF INVENTION

The present invention relates generally to mitigation of pollutants emitted by facilities associated with oil extraction and processing, and more specifically, to mitigation of pollutants emitted by facilities associated with oil extraction facilities using photobioreactors.

### BACKGROUND

Oil extraction and production facilities, for example for extracting and/or producing liquid fuel products from mined solid materials such as oil sands and oil shale, are likely to become critical components of the solutions to many of the world's, and especially North America's growing need for alternative sources of fossil fuels. Unfortunately, as described below, typical oil extraction and production facilities configured to process these alternative sources of fossil fuels are major producers of greenhouse gases, such as carbon dioxide (CO₂). To highlight one important example, the oil sands in Alberta, Canada comprise one of the world's largest sources of bitumen. Oil sands are also found in Venezuela, and to a lesser extent, in the United States and other countries. Oil sands (also known as tar sands and bituminous sands) are a mixture of, primarily, bitumen, sand and water. Bitumen is a heavy black viscous oil that must be upgraded before it can be refined to produce gasoline and diesel fuels. Oil sands recovery processes generally include extraction and separation systems to remove the bitumen from sand and water. Oil sands that are deposited at or near the surface of the earth can be recovered by open-pit mining techniques. Typically, large excavation machines such as large trucks and shovels are used to excavate and transport oils sands to an extraction facility, where bitumen can be separated from the sand and water using, for example, hot water (e.g., 80 degrees C.) and a base (e.g., sodium hydroxide) in a first stage and, in a second stage involving centrifugation and a solvent (e.g., naphtha, a gasoline-like product) (see e.g., the Athabasca website at http://collections.ic.gc.ca/oil/litr06.htm). Oil sands that are buried below the surface that cannot be recovered by surface mining techniques may be excavated by in-situ thermal recovery techniques, such as cyclic steam stimulation (CSS) and steam assisted gravity drainage (SAGD) processes. In-situ techniques involve drilling wells into the earth and injecting steam to heat the bitumen, allowing it to flow and to be produced from a well, much like conventional oil production.

Typically, the bitumen is “upgraded” into a synthetic crude oil and/or blended with a diluent before it can be refined. The bitumen may be rigorously treated with heat and/or diluted with a light hydrocarbon (termed “cutting stock”), so that it can be more readily transportable by pipelines. Upgrading techniques typically fall within one of two broad categories: carbon removal or hydrogen addition. Carbon removal, or “coking”, involves catalytically “cracking” the bitumen using heat to form lighter oils and coke, a solid carbonaceous byproduct. Hydrogen addition, “hydrocracking”, typically involves cracking the bitumen into lighter oils by the addition of hydrogen (i.e., hydrogenation) to increase in the hydrogen to carbon ratio. Both processes typically involve the production of large amounts of CO₂, a greenhouse gas.

Accordingly, the oil sands industry faces several challenges. First, the industry has a relatively high and growing rate of CO₂ emissions. Second, oil sands extraction processes require large quantities of cutting stock to facilitate pipelining product to markets. Third, the oil sands extraction and processing steps generate large quantities of waste heat which is underutilized, lowering overall energy efficiency.

The oil sands industry has addressed CO₂ emissions by a combination of energy efficiency and conservation techniques. While work continues, these approaches have limits to the degree of CO₂ reduction. More recently, the industry has begun investigating CO₂ capture with the intent to sequester CO₂ in oil and gas underground formations. The cost for this process is relatively high, due to the need to construct a large infrastructure of CO₂ distribution and injection equipment. There are also regulatory and environmental problems associated with this approach.

The need for cutting stock has been addressed by building parallel pipelines from the oil sands region to the receiving sites. Product is thinned at the oil sands production site with cutting stock, and sent to the receiving site in one pipeline. At the receiving site, the cutting stock is recovered and returned to the production site via the second pipeline. The separation and transportation costs for the transit of the cutting stock is relatively high. However, there is not a sufficient source of cutting stock available at the production site to reduce the need to cycle cutting stock between the production and receiving facilities.

The waste heat from oil sands operations is currently dissipated in large open holding ponds, with no useful recovery of the thermal energy. The holding ponds are used to hold water for extended periods of time to allow materials to settle or decompose; these ponds often have environmental liabilities and low productivity. For instance, various techniques are used to restrict animals for accessing the ponds, which may contain toxic levels of certain compounds.

Although current oil sands extraction and processing facilities are able to tap into one of the world's largest oil reserves, these facilities have major environmental impacts. What is needed are processes for reducing net production and additional release to the atmosphere of greenhouse gases such as CO₂, as well as reduction of the consumption of water, gas, and other resources. Similarly, for this and other oil extraction and production technologies producing large quantities of greenhouse gasses, techniques are needed to enable removal or abatement of such greenhouse gases and productive utilization of the carbon contained in such gases.

### SUMMARY OF THE INVENTION

Methods and systems associated with mitigation of pollutants emitted by facilities associated with oil extraction and processing are provided. In one embodiment, an integrated oil processing and gas remediation method is provided. The method comprising acts of processing an oil extracted from a mixture of an oil and a solid material excavated from the earth to produce a processed oil product, wherein a byproduct gas stream is produced during the processing act, and passing at least a portion of the byproduct gas stream into an inlet of a photobioreactor system containing a liquid medium therein comprising at least one species of phototrophic organisms. The method also comprises at least partially removing at least one substance from the byproduct gas stream with the phototrophic organisms, the at least one substance being utilized by the organisms for growth and reproduction.

In another embodiment, an integrated oil production and gas treatment system is provided. The integrated system comprises an oil extraction and processing facility configured to extract oil from a mixture of an oil and a solid material excavated from the earth and to process extracted oil to produce a processed oil product, wherein the facility comprises at least one gas outlet from which is emitted a byproduct gas stream. The integrated system also includes a photobioreactor system containing a liquid medium comprising at least one species of phototrophic organisms, at least a portion of the photobioreactor system being configured to transmit light to the phototrophic organisms, the photobioreactor system comprising an inlet connected in fluid communication with at least one gas outlet of the facility, the photobioreactor system further comprising an outlet configured to release treated gas from the photobioreactor system.

In another embodiment, a method of producing biomass is provided. The method comprises acts of providing a liquid medium comprising at least one species of phototrophic organisms within a photobioreactor system and exposing at least a portion of the photobioreactor system and the at least one species of phototrophic organisms to a source of light capable of driving photosynthesis. The method also includes introducing a byproduct gas stream derived at least in part from an oil extraction and processing facility configured to extract oil from a mixture of an oil and a solid material excavated from the earth and to process extracted oil to produce a processed oil product, and/or introducing a byproduct gas stream derived from a furnace and/or electrical power generating system associated with the oil extraction and processing facility, to an inlet of the photobioreactor system, and harvesting at least a portion of the phototrophic organisms from the photobioreactor system to form biomass.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic process flow diagram of an integrated oil sands facility and photobioreactor system according to one embodiment of the invention;

FIG. 2 is a perspective view of a photobioreactor unit adapted to float on a body of water according to one embodiment of the invention;

FIG. 3A is a perspective view of a photobioreactor unit according to one embodiment of the invention;

FIG. 3B is a cross-sectional view of one photobioreactor section of a photobioreactor unit according to one embodiment of the invention;

FIG. 4 is a perspective view of a photobioreactor system according to one embodiment of the invention;

FIG. 5 shows a block diagram of an overall gas treatment/biomass production system comprising a photobioreactor system according to one embodiment of the invention;

FIG. 6 is a cross-sectional view of a nutrient misting section of a photobioreactor section according to one embodiment of the invention;

FIG. 7 is a perspective view of an evaporative cooling zone of a photobioreactor unit according to one embodiment of the invention; and

FIG. 8 shows a plot of algal growth rates as a function of time according to one embodiment of the invention.

### DETAILED DESCRIPTION

Certain embodiments and aspects of the present invention relate to integration of a photobioreactor system designed to contain a liquid medium comprising at least one species of phototrophic organism therein, with a facility associated with extracting and/or processing oil extracted from mixtures of oil and solid material, such as an oil sands or oil shale facility. Processes for using a photobioreactor system as part of a gas-treatment process and system able to at least partially remove certain undesirable pollutants from a byproduct gas stream produced by a facility associated with extracting and/or processing oil extracted from mixtures of oil and solid material, specifically exemplified by an oil sands facility, are also described. Examples of such pollutants that may be removed include compounds contained within combustion gases, e.g., CO₂ and/or NOₓ. These pollutants may be subsequently processed by a photobioreactor system, and, in some embodiments, utilized to produce a fuel source (e.g., a dried biomass coal substitute, biodiesel, methane, ethanol, syngas/hydrogen, etc.) and/or cutting stock for further operation of the oil sands facility. Such uses according to certain embodiments of the invention can provide an efficient means for recycling carbon, thereby reducing CO₂ emissions, fuel, and/or cutting stock requirements for a given quantum of energy produced. In addition, in some cases the photobioreactor can be integrated with a holding pond, and waste heat from the oil extraction process can be used to maintain the photobioreactor temperature and/or provide energy for other processes. In certain such embodiments, a photobioreactor may be configured to float on top of at least a portion of such a holding pond, adding a further benefit of blocking access of water fowl and other wildlife to the pond. Accordingly, certain embodiments of the invention can improve the overall environmental and economic profile of an oil sands facility.

In addition to performing remediation of byproduct gas streams, integration of photobioreactors can be advantageous due to the production of useful, high-value products from waste CO₂ and/or NOₓ produced by oil sands extraction and/or processing facilities. Production of algal biomass during gas treatment for CO₂ reduction is economically and environmentally attractive since dry algae has a heating value roughly equivalent to coal. Algal biomass can also be turned into high quality liquid fuel (similar to crude oil) through thermochemical conversion by known technologies. Algal biomass can also be used for gasification to produce highly flammable organic fuel gases, suitable for use in gas-burning power plants or may be converted using known technologies into hydrogen fuel or other useful non-fuel products, as described in further detail in U.S. Patent Publication No. 2005/0064577, filed on Aug. 23, 2004, entitled, “Hydrogen Production with Photosynthetic Organisms and Biomass Derived Therefrom,” by Berzin, and U.S. Patent Publication No. 2005/0239182, filed on Apr. 14, 2005, entitled, “Synthetic and Biologically-Derived Products Produced Using Biomass Produced By Photobioreactors Configured for Mitigation of Pollutants in Flue Gases,” by Berzin, which are incorporated herein by reference.

Although much of the description herein involves an exemplary application of the present invention related to utilizing photobioreactors for remediating byproduct gases associated with oil sands extraction and/or processing facilities, the invention and its uses are not so limited, and it should be understood that the invention can also be used to remediate gases and/or convert gases to useful forms of energy in other settings. For instance, photobioreactors may be integrated with other facilities involving extraction and/or processing of oil from mixtures of oil and solid material, such as oil shale facilities.

Certain embodiments of the invention are directed to integrating a bioreactor, such as a photobioreactor, with an oil extraction and/or processing facility, such as an oil sands extraction and/or processing facility. A “photobioreactor,” as used herein, refers to an apparatus containing, or configured to contain, a liquid medium comprising at least one species of phototrophic organisms and having either a source of light capable of driving photosynthesis associated therewith, or having at least one surface at least a portion of which is partially transparent to light of a wavelength capable of driving photosynthesis (i.e., light of a wavelength between about 400-700 nm, which can be emitted by the sun or another light source). Preferred photobioreactors for use herein may comprise an at least partially enclosed photobioreactor system, as contrasted with a totally open photobioreactor, such as open tanks, open, uncovered channels, etc., as discussed in more detail below.

The term “phototrophic organism” or “biomass,” as used herein, includes all organisms capable of photosynthetic growth, such as plant cells and micro-organisms (including algae, cyanobacteria, lemna and euglena) in unicellular or multi-cellular form, that are capable of growth in a liquid phase (except that the term “biomass,” when appearing in the titles of documents referred to herein or in such references that are incorporated by reference, may be used to more generically to refer to a wider variety of plant and/or animal-derived organic matter). These terms may also include organisms modified artificially or by gene manipulation. While certain photobioreactors disclosed in the context of the present invention are particularly suited for the cultivation of algae, or phototrophic bacteria, and while in the discussion below, the features and capabilities of certain embodiments of the inventions are discussed in the context of the utilization of algae (i.e., algal biomass) as the phototrophic organisms, it should be understood that in other embodiments, other phototrophic organisms may be utilized in place of or in addition to algae, and other photobioreactors than those specifically disclosed may be used. For an embodiment utilizing one or more species of algae, algae of various types (for example, Chlorella, Spirolina, Dunaliella, Porphyridum, etc.) may be cultivated, alone or in various combinations, in the photobioreactor. Additionally, in certain embodiments the photobioreactors of the invention may use pre-conditioned or pre-adapted algae optimized for growth at the particular operating conditions expected within the photobioreactor gas treatment systems as described in more detail in commonly-owned U.S. Patent Application Publication No. 2005/0064577 A1, which incorporated herein by reference.

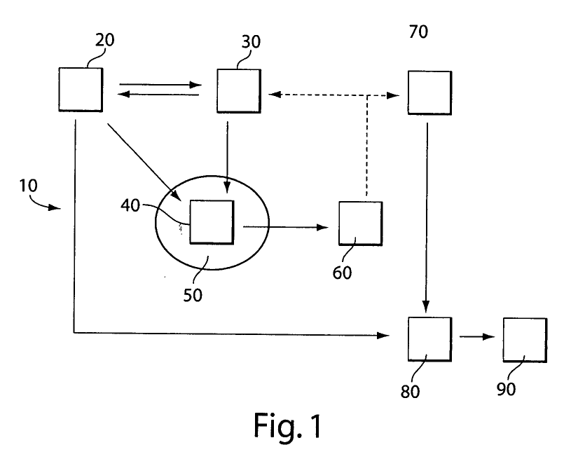

FIG. 1 illustrates one embodiment of an integrated system 10 for performing an integrated oil extraction/processing and gas remediation/biomass production process, wherein byproduct gases from an oil sands facility 20 (e.g., an oil sands extraction and/or processing facility) and/or a heat and/or power generating facility 30 associated therewith, are treated with a photobioreactor system 40 to mitigate one or more pollutants from the gases. Phototrophic organisms contained in the photobioreactor may remove one or more substances (e.g., CO₂ and/or NOₓ) from the byproduct gas stream(s), which can then be utilized by the organisms for growth and reproduction. The photobioreactor system can include an outlet configured to release treated gas from the bioreactor system, for example to the atmosphere. In some cases, the photobioreactor system is suspended in (e.g., floats upon) a large open pond of water (e.g., holding pond) 50. The open pond(s), which typically in an oil sands facility is used as a waste heat repository, can be used to maintain operating temperature of the photobioreactor as ambient temperatures vary throughout the day and year.

If desired, the integrated system can be used to produce and harvest a biomass product, for example in the form of harvested algae. In such embodiments, at least a portion of the phototrophic organisms can be removed from the photobioreactor system to form a harvested biomass product, which can then be dewatered in any of a variety of conventional dewatering systems 60. Optionally, at least a portion of the biomass product, either prior to or subsequent to dewatering, can be at least partially converted into liquid products such as vegetable oil, ethanol, cutting stock and biodiesel, in the liquid biofuel processing unit 70. In certain embodiments, integrated system 10 may comprise other unit operations for converting harvested biomass into gaseous or solid products, such as organic fuel gas (e.g., methane), syngas/hydrogen, solid biomass fuel, food products, bioplastics, pharmaceutical/nutraceutical products, etc. Residual biomass from this operation and/or any of the fuel products produced from such biomass mentioned above can optionally be “recycled” (i.e., the carbon in the byproduct gases is recycled) to the heat and/or power generating facility 30 and/or to other combustion devices, vehicles, equipment, etc. of the facility as fuel. In some cases, at least a portion of the liquid products from the process can be blended with raw (unprocessed) and/or processed oil products from the oil sands facility 20 at pipeline pumping station 80. The combined products may be sent to the downstream processing facility 90, where the liquid biofuel can be separated and/or co-processed/refined with the oil. Accordingly, in addition to mitigating pollutants in byproduct gases from oil sands facility and/or heat/power generating operations associated therewith, integrated systems of the invention can, in certain embodiments, utilize one or more substances from the offgases to produce an on-site, continuous supply of biomass and/or liquid fuel or gaseous fuel products.

Photobioreactor system 40 can be integrated with an oil sands facility 20 that includes either, or both, of an oil extraction facility and a processing facility (e.g., an oil upgrading facility). As such, byproduct gases from either, or both, of the extraction and/or processing operations can be introduced into the photobioreactor system for gas remediation. This can be done, for example, by connecting at least one gas outlet of the gas emitting facility to an inlet of the photobioreactor system, such that the facility and the photobioreactor system are in fluid communication with one another.

In some embodiments, the oil sands facility includes an open-pit mining (or surface mining) extraction facility for recovering bitumen deposited at or near the surface of the earth. As described above, open-pit mining facilities typically involve large excavation machines such as large trucks and shovels that are used to excavate and transport oil sands to an extraction/processing facility. Bitumen can be separated from the sand and water at the extraction facility by a “hot water treatment” process, i.e., using hot water (e.g. at about 80 degrees C.) and a base (e.g., sodium hydroxide) to detach bitumen from the sand. This process creates a slurry of oil and sand, which can be pumped into one or more separation tanks, where the oil and sand slurry can settle into different layers. Typically, the bitumen rises to the top and the sand (termed “tailings sand”) sinks to the bottom. The tailings sand and excess water are pumped into one or more holding ponds, while the bitumen is collected and thinned using a solvent such as naphtha, a gasoline-like product, which increases the rate of separation. After separation of the solvent from the bitumen, the solvent can be recycled for further use in the extraction process and the bitumen can be sent to the upgrading facilities.

In other embodiments, photobioreactor system 40 is integrated with an oil sands facility 20 that involves in-situ techniques for recovering bitumen; that is, bitumen deposits that are buried too deeply to use surface mining techniques, e.g., more than 75 meters. Examples of known in-situ techniques include cyclic steam stimulation (CSS) and steam assisted gravity drainage (SAGD) processes, which involve drilling vertical or horizontal wells into the earth, injecting steam and/or solvent to heat the bitumen, and allowing the bitumen to flow to the surface. The bitumen can then be diluted, e.g., with cutting stock, for shipping by pipelines or upgraded on-site to form lighter hydrocarbons.

In some embodiments, byproduct gases produced by oil sands processing facilities are directed to the photobioreactor system for remediation of pollutants. Typical oil sands processing facilities involve upgrading the bitumen to produce lighter oils, such as synthetic crude oil, which are then suitable for pipeline transport to a refinery. The upgrading process may also involve removal of impurities, such as nitrogen, sulfur and/or carbon.

In one embodiment, processing (e.g., upgrading) bitumen involves coking; that is, cracking (or breaking down) bitumen using heat and catalysts to form lighter oils and petroleum coke, a solid material carbon byproduct that resembles coke but contains many impurities such as sulfur, vanadium, and nickel. The production of the heat required to drive this process also typically produces byproducts such as CO₂ (e.g., via combustion of fuel in furnaces), which can be introduced into a photobioreactor system for remediation and, optionally, for the production of biomass products.

The upgrading process can also or alternatively involve hydrocracking and, optionally, hydrodesulphurization. The process of hydrocracking involves adding hydrogen to the oil and, optionally, removing sulfur from the oil to produce a more purified oil product comprising lighter, more saturated hydrocarbons. Hydrocracking typically involves conventional catalytic steam reforming technologies to produce from methane and/or other light hydrocarbons a hydrogen-containing product gas from methane and steam combined with water-gas-shift reactor systems that use additional steam to “shift” the carbon monoxide produced by the reformer into additional hydrogen to produce a hydrogen-rich syngas, which also comprises copious amounts of CO₂. The reforming step of the above process catalytically reacts organic gases with steam in a exothermic reaction (e.g., 200-500 degrees C.) to form hydrogen and CO:

CH₄+H₂O→CO+3H₂

In a second reaction, the water gas-shift (WGS) reaction, the CO is then “shifted” with steam (e.g., at 700-1100 degrees C. to form additional hydrogen and CO₂ in an endothermic reaction:

CO+H₂O→CO₂+H₂

The hydrogen produced from this reaction may then be used to as a feed to a catalytic hydrogenation reactor, which upgrades the bitumen via hydrogenation:

CHₙ+H₂→CHₙ₊₂

As can be seen, the major products of this scheme are upgraded oil (CHₙ₊₂) and byproduct CO₂. Additional CO₂ is typically generated by the furnace(s) and/or steam generating devices used to provide the heat and steam for these reactions. Hydrocracking methods are well known in the art (see, for example, Froment, et al., Hydrotreatment and Hydrocracking of Oil Fractions: Proceedings of the 2nd International Symposium, 7th European Workshop, Antwerpen, Belgium, Nov. 14-17, 1999, Elsevier Science Ltd. (1999); and Scherzer, et al., Hydrocracking Science and Technology, Marcel Dekker, Inc., (1996)).

Additionally or alternatively, oil sands facility may include a thermal/catalytic coking reactor, which heats hydrocarbons under anoxic conditions to “crack” the bitumen to form lighter hydrocarbons with petroleum coke and hydrogen as primary byproducts. CO₂ is generated by the furnace(s) used to provide the heat energy required to drive these reactions. Coking methods are well known in the art (see, for example, Gray, “Fundamentals of Bitumen Coking Processes Analogous to Granulations: A Critical Review”, The Canadian Journal of Chemical Engineering, Volume 80, pp. 393-401, June 2002; and Christopher, Modern Coking Practice, C. Lockwood and son; 2nd edition (Jan. 1, 1917); and Liberman, “Studies of the Chemistry of Hydrocarbons and Their Catalytic Conversions,” Volume 30, No. 5, pp. 237-251 (1961)).

Accordingly, oil sands facility 20 may include one or more of a coking reactor, a catalytic reforming and/or water-gas-shift reactor, and/or a catalytic oil hydrogenation reactor, and associated furnaces, boilers, heaters, power generating facilities etc., one or more of which can be fluidly connected to a photobioreactor system for mitigation of byproduct gases. A wide variety of systems, reactors, and processes for performing upgrading reactions are known and available to those skilled in the art. It should be understood that photobioreactors can be integrated with other types of facilities associated with extracting and/or processing oil from a mixture of an oil and solid material, based upon general knowledge of the art in combination with the description herein.

As is apparent from the above description, integrated photobioreactor gas treatment system 10 can provide a biotechnology-based air pollution control and renewable energy solution to oil sands facilities. In certain embodiments, the integrated system can include a heat and/or power generating system configured to provide heat and/or power to facilitate oil extraction and/or processing of extracted oil. For instance, the heat and/or power generating system may be used to provide thermal energy to one or more of a coking reactor, a catalytic reforming and/or water-gas-shift reactor, a catalytic oil hydrogenation reactor, and/or other systems used for processing and/or extracting oil. Heat and/or power generating facility 30, may include, for example, a fossil fuel burning facility, a natural-gas combined-cycle power plant, and/or a coal burning power plant. Byproduct gas streams containing CO₂ and/or other gases such as nitrogen oxides (NOₓ) and sulfur dioxide (SO₂) emitted from one or more gas outlets of these gas-emitting facilities may be directed to the photobioreactor system for mitigation of gases and/or for conversion into biomass or other energy products.

Integrated system 10 can be advantageously utilized to both reduce the level of pollutants emitted from one or more combustion facilities associated with the oil sands facility into the atmosphere and, in certain embodiments, to reduce the amount of fossil fuels, such as coal, oil, natural gas, etc., burned by the facility. Such a system can also potentially be advantageously utilized for treating gases emitted by facilities such as fossil fuel (e.g., coal, oil, and natural gas)—fired power plants, natural-gas combined-cycle power plants, industrial incineration facilities, industrial furnaces and heaters, internal combustion engines, electrical power generating systems, etc. Integrated system 10 can, in some cases, substantially reduce the overall fossil fuel requirements of a combustion facility, while, at the same time, substantially reducing the amount of CO₂ and/or NOₓ released as an environmental pollutant, and, in certain embodiments providing biomass useful in producing a fuel product. In addition, integrated systems of the invention can address the industry's issues regarding cutting stock production and cycling, waste heat utilization, and beneficial use of the large holding ponds (e.g., via utilization of the waste heat sent to the holding pond as a source of heat for maintaining the inventive photobioreactor systems at operating temperatures, as described in more detail below). For example, as extracted oil is often thinned at the oil sands facility with cutting stock to facilitate pipelining, typically with a light hydrocarbon that acts as a diluent, an on-site integrated gas remediation and photobioreactor system according to the invention can produce a continuous and sufficient source of cutting stock (e.g., in the form of light vegetable oil extracted, by conventional means, from harvested biomass and/or in the form of biodiesel produced from the biomass) available at the production site to reduce or eliminate the need to cycle cutting stock between the oil production and receiving facilities. Accordingly, the process of using, for example, algal oil or liquid biofuel as a source of cutting stock can advantageously reduce the amounts of cutting stock required to be imported into the facility. Furthermore, as mentioned above, in certain embodiments, waste heat, which may be dissipated in a holding pond, from the oil sands extraction and/or processing steps can be used to maintain and/or operate the photobioreactor. For example, waste heat may be used to maintain photobioreactor temperature and/or to promote biomass separations and processing in the cutting stock production steps.

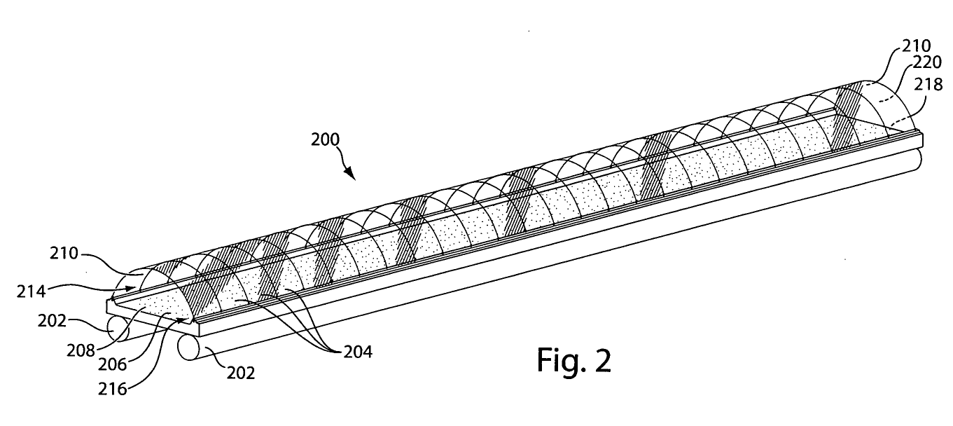

As described above, any combustion gases produced by the oils sands facility and/or the heat and/or power generating facility can be introduced into the photobioreactor. Optionally, in some embodiments, combustion gases, e.g., hot flue gases, may be passed through a heat exchanger comprising a dryer, the function of which is explained below. The heat exchanger can be configured and controllable to allow the hot gases to be cooled to a desired temperature for injection into the photobioreactor. In certain embodiments in which photobioreactors comprise gas spargers for gas introduction into a liquid media containing the phototrophic organisms, gases being introduced into the photobioreactor system for treatment are compressed with a compressor. In alternative embodiments, photobioreactors are configured, e.g., as illustrated and described in the context of FIGS. 2-7, such that mass transfer does not involve injecting or sparging gas into the liquid medium. In such embodiments, a compressor may not be necessary and the gas may pass through the photobioreactor system without compression or supplemental motive force. In certain embodiments, motive force for gas flow through the photobioreactor system may be created or supplemented by the uses of blower(s) connected upstream of the photobioreactor inlet and/or downstream of the photobioreactor outlet (induced draft). The gas, upon passing through the photobioreactor, is treated by the algae or other phototrophic organisms therein to remove one or more pollutants therefrom, for example, CO₂ and/or NOₓ. Treated gas, containing a lower concentration of CO₂ and/or NOₓ than the feed gas can be released from an outlet of the photobioreactor and, in one embodiment, vented to the atmosphere.

Integrated system 10 can include one or more types of photobioreactor systems 40. Photobioreactor systems suitable for integration with oil sands or other oil extraction/processing operations may advantageously be configured to operate with minimal pressure drop for the feed gas to reduce overall parasitic energy consumption by the system. For instance, in some embodiments, the photobioreactor may operate with an average gas flow pressure drop of less than 10 psi, less than 7 psi, less than 5 psi, less than 3 psi, less than 2 psi, or less than 1 psi. Certain photobioreactors may use sparging to mix the CO₂-containing gas with the algae-containing media. Spargers are typically designed to produce small bubbles and operate at liquid depths greater than 20 cm, resulting in a pressure drop for the gas feed that is typically greater than 1 psi, and often in the 5-10 psi range. Consequently, in some embodiments, a non-sparged reactor is provided for use in the photobioreactor systems described herein.

In some cases, e.g., depending on the climate of the particular region, photobioreactor systems suitable for integration with an oil sands facility or other oil extraction/processing facility are at least partially enclosed, or may be essentially fully enclosed, for instance to prevent freezing during winter months and/or provide a conduit in which gas undergoing treatment flows in contact with the liquid medium containing phototrophic organisms. Providing an at least partially enclosed photobioreactor can also reduce the potential for adventitious species to enter the system, and can prevent rain, snow, and hail form diluting or cooling the media. Moreover, the use of a partially or fully enclosed system can also reduce access to dirt, dust, animals, and other contaminants that may negatively impact operations. In certain cases, however, open photobioreactor systems may be suitable. Examples of open and closed photobioreactor systems are described in more detail below.

In certain embodiments, a photobioreactor system suitable for integration with an oil sands or other oil extraction/production facility is capable of utilizing waste heat from the facility, such as waste heat from the oil sands extraction process. Heat may be utilized, for example, by associating the photobioreactor with a holding pond used as a repository for waste heat. Holding ponds are typically used as natural remediation sites to hold water for extended periods of time to allow materials to settle or decompose; they are also used as heat sinks for the oil sands operations. In one particular embodiment, a photobioreactor is configured and arranged to float on a holding pond, as described in more detail below. In this configuration, the photobioreactor can directly benefit from waste heat rejected to the ponds, and can also beneficially reduce the open area of the ponds accessible to water fowl and other wildlife. Additionally, in other embodiments, the photobioreactor may be heated from a source independent of the oil sands or other oil extraction/processing facility, e.g., by waste heat from a power generating system.

The photobioreactor can be heated and maintained at certain temperatures or temperature ranges suitable or optimal for productivity. These specific, desirable temperature ranges for operation will, of course, depend upon the characteristics of the phototrophic species used within the photobioreactor systems, the type of photobioreactor, etc. Typically, it is desirable to maintain the temperature of the liquid medium between about 5 degrees C. and about 45 degrees C., more typically between about 15 degrees C. and about 37 degrees C., and most typically between about 15 degrees C. and about 25 degrees C. For example, a desirable temperature operating condition for a photobioreactor utilizing Chlorella algae could have a liquid medium temperature controlled at about 30 degrees C. during the daytime and about 20 degrees C. during nighttime. In one embodiment, the temperature of the photobioreactor is maintained at about 20 degrees C.

Furthermore, photobioreactor systems suitable for integration with an oil sands or other oil extraction/production facility may advantageously be configured such that they are practical to deploy over large areas, for example, ranging from hundreds to thousands of acres. Accordingly, in certain embodiments, a photobioreactor system integrated with an oil sands or other oil extraction/production facility is deployed over at least 100 acres, at least 300 acres, at least 500 acres, at least 800 acres, at least 1,000 acres, at least 2,000 acres, at least 5,000 acres, at least 7,000 acres, or at least 10,000 acres. The photobioreactor system may span, for example, between 20-100 acres, between 100-500 acres, between 500-1,000 acres, between 1,000-2,000 acres, between 2,000-5,000 acres, between 5,000-7,000 acres, or between 7,000-10,000 acres. In instances in which the photobioreactor system is floated upon a holding pond associated with an oil sands facility, the photobioreactor system may span at least 10%, at least 20%, at least 30%, at least 40%, at least 50%, at least 60%, at least 70%, at least 80%, or at least 90% of the surface area of the holding pond.

As described above, many oil extraction/processing facilities such as oil sands facilities include ponds or other bodies of water to which waste heat is discharged. In some embodiments, especially in colder climates, a photobioreactor may be positioned on top of a waste water pond to achieve one or more possible advantages. By floating or otherwise positioning a photobioreactor on or over a body of water, the photobioreactor system may take advantage of the inherent flatness of the surface of a body of water over an expansive area. Further, by using an already existing pond, no or limited additional geographic area is required for the photobioreactor system. If the body of water accepts heated waste water from the power plant (or other source) the photobioreactor system can be heated by the body of water to improve biomass production and/or prevent freezing in cold ambient conditions. In certain embodiments, photobioreactor system 40 of FIG. 1 can be similar or identical in design and configuration to that shown in FIG. 2 and described in more detail in commonly-owned U.S. Provisional Patent Application No. 60/819,976, filed on Jul. 10, 2006, entitled, “Photobioreactor Systems and Methods for Treating CO₂-Enriched Gas and Producing Biomass” by Lewnard et al, which is incorporated herein by reference. Photobioreactor unit 200 of FIG. 2 is adapted for positioning on a body of water and is supported by two pontoon floats 202 that extend longitudinally along the length of the photobioreactor unit. Of course, other structures may be used to float or support one or more photobioreactor units on a body of water. This design can have a low gas pressure drop, may be at least partially covered and/or enclosed (e.g., to reduce heating requirements, provide effective gas flow and gas/liquid mass transfer, etc.), and can be deployed over large areas. In alternative embodiments, other photobioreactors can be utilized, such as those described in commonly-owned U.S. Patent Publication No. 2005/0260553, filed on Nov. 24, 2005, entitled, “Photobioreactor and Process for Biomass Production and Mitigation of Pollutants in Flue Gases”, by Berzin; and PCT Publication No. US2005/025249, filed on Jul. 18, 2005, entitled, “Photobioreactor and Process for Biomass Production and Mitigation of Pollutants in Flue Gases, by Berzin et al, both of which are incorporated herein by reference in their entirety. Alternatively, other photobioreactor designs known in the art may be used for at least a portion of the photobioreactors comprising system 40 (which may or may not be deployed as floating structures). Many photobioreactors useful or potentially useful in the context of inventive integrated system 10 are described in more detail below. Accordingly, unit operations can be of conventional designs, or of straightforward adaptations or extensions of conventional designs, and can be selected and designed by those of ordinary skill in the chemical engineering arts using routine engineering and design principles.

In some embodiments, photobioreactor system 40 of FIG. 1 can be of the design of photobioreactor unit 200 of FIG. 2 or a system comprising a plurality of such units interconnected in a series and/or parallel configuration as described in greater detail in U.S. Provisional Patent Application No. 60/819,976, filed Jul. 10, 2006, and entitled “Photobioreactor Systems and Methods for Treating CO₂-Enriched Gas and Producing Biomass”. Photobioreactor system 40 can include one or more longitudinally oriented, elongated covered photobioreactor units 200 arranged in parallel that extend across a land area or a body of water, such as a pond. Photobioreactor unit 200 can include at least one photobioreactor section 204, the photobioreactor unit being constructed and arranged to carry a flow of liquid medium 206 comprising phototrophic organisms therein. In certain embodiments, each photobioreactor unit may have a liquid channel 208 (formed by a trench in some embodiments) and a gas headspace 210 (enclosed by a light-transparent cover in some embodiments). The cover(s), if present, may be constructed and arranged to cover at least a substantial portion of the liquid flow channel. The cover(s) may also be configured to be capable of providing the gas headspace even when a gas pressure within the photobioreactor unit is less than the atmospheric pressure surrounding the photobioreactor section (e.g., they may be rigid or semi-rigid and self supporting). CO₂-rich gas can be made to enter the photobioreactor unit via inlet 214 and flow in the headspace 210 above a liquid medium 206 comprising at least one phototrophic organism such as algae. The algae uses the CO₂ from the gas and the light that passes through the cover to grow and produce biomass. Such photobioreactors may also include a liquid inlet 216 to provide liquid medium to the upstream photobioreactor section, a liquid outlet 218 from which to remove liquid medium comprising phototrophic organisms therein from the photobioreactor section, a gas inlet 214 to provide gas containing an elevated concentration of carbon dioxide into the gas headspace, a gas outlet 220 from which to remove gas containing carbon dioxide at a concentration less than at the gas inlet, and/or a blower or induced-draft fan (not shown) fluidically connected to the gas outlet able to create a flow of gas through the gas headspace from the gas inlet to the gas outlet. A blower is considered to be fluidically connected to a photobioreactor unit even if it is not directly connected to the photobioreactor unit; that is, other pieces of equipment or other conduits may be connected between the photobioreactor unit and the blower. Optionally, some units may include a second liquid outlet (not shown) positioned between a first liquid inlet and a first liquid outlet, from which the liquid medium is removable from the photobioreactor unit, as well as a channel fluidically interconnecting the second liquid outlet to the photobioreactor unit at a position which is upstream of the second liquid outlet to enable return and recycle of the liquid medium within the photobioreactor unit.

In some embodiments, a photobioreactor section 204 of a photobioreactor unit comprises a first portion of the photobioreactor section in which the cover provides the gas headspace over a first portion of the liquid medium. The unit may also include a second, different portion of the photobioreactor section in which a second portion of the liquid medium is exposed to gas outside of the gas headspace, for example by means of a sparger or fountain configuration, to facilitate evaporative cooling of the liquid medium. The photobioreactor system can optionally include a controller configured to control the amount of evaporative cooling of the liquid medium in the portion of the photobioreactor section where the liquid medium is exposed to gas outside of the gas headspace.

In some embodiments, the flow of gas and liquid through the photobioreactor units may experience limited or essentially no backflow, and in this way exhibit the characteristics of a plug flow system. With limited backflow, longitudinal zones may be defined in which different operating conditions such as, for example, algae density, liquid temperature, gas composition, gas temperature, media composition, media agitation/turbulence, gas/liquid mass/heat transfer, light exposure, media depth, etc. are generally known and controllable by changing operating parameters. For example, a single photobioreactor unit may include different zones within which one or more of the following operating parameters vary and/or are known and/or are controllable: nutrient concentrations; temperature; pH; liquid depth; surface-to-air ratio of the liquid; agitation levels; and others. In certain embodiments, these zones may be made up by or comprise one or more specially configured photobioreactor sections of the photobioreactor unit.

In some embodiments, advantages of a back-mixed bioreactor may be achieved while maintaining many of the characteristics of a plug flow bioreactor. One or more reflow zones may be used to return algae-rich liquid from, for example, a longitudinal mid-area of the photobioreactor unit to the front end of the photobioreactor unit or to some other position upstream of the liquid removal position. By doing so, the addition of new innocula to the liquid medium at the front end of the photobioreactor unit may be reduced or eliminated and/or other desirable operating parameters may be maintained and/or established.

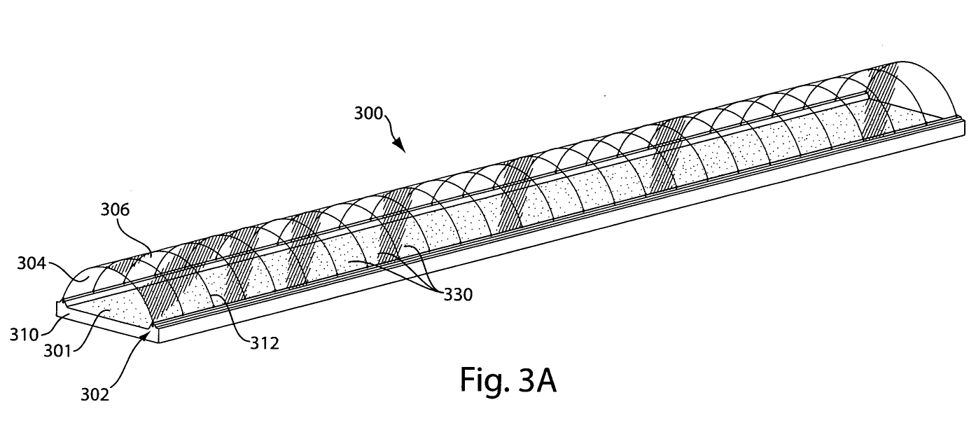

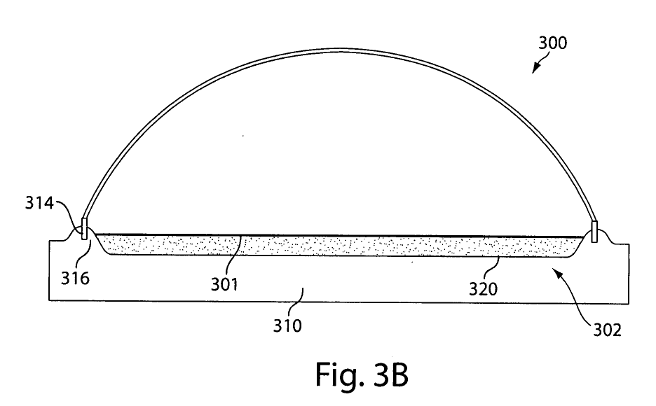

One embodiment of a photobioreactor unit 300 that can be used in photobioreactor system 40 of FIG. 1 and which may, in certain embodiments, be further configured to include pontoons or other floatation devices (not illustrated for simplicity), is shown in FIGS. 3A and 3B. Liquid medium 301 flows along a trench (or, equivalently, channel) 302 within photobioreactor unit 300, and gas, such as a byproduct gas stream produced by a facility associated with extracting and/or processing oil extracted from a mixture of oil and solid material, flows through a gas headspace 304 formed between liquid medium 301 and a cover(s) 306, which may be at least partially transparent to light. Cover(s) 306 may be constructed such that gas headspace 304 remains essentially constant when no gas pressure or a negative gas pressure is applied to the interior of photobioreactor unit 300.

As CO₂-rich gas flows over liquid medium 301, CO₂ dissolves into the liquid medium, and algae within the liquid medium use the CO₂ and sunlight (or other light source) to photosynthesize, grow and reproduce, thereby producing biomass. The liquid medium flows, in certain embodiments at a controlled rate, through photobioreactor unit 300, and the algae, in some cases, is harvested at an outlet of photobioreactor unit 300 by removing the algae-rich liquid from the photobioreactor unit.

In some embodiments, photobioreactor unit 300 may be approximately 10 meters wide and the overall photobioreactor unit 300 may be a suitable length to process a desired amount of CO₂. In general, the photobioreactor unit length exceeds the width, and the ratio of length to width may be greater than 100:1, and may exceed 1000:1. However, other configurations are also possible. The gas containing elevated concentrations of CO₂ (i.e., CO₂ concentrations which are higher than ambient air) may range from 1%-100%, but typically in the range of 4-20%. The operating pressure of the photobioreactor may generally range from about 11-20 psia, preferably from 13-16 psia. Flow rates of the gas may generally range from about 0.05-50 cm/sec, or other suitable flow rate. Liquid flow rates may generally range from about 1-100 cm/sec. Biomass concentrations generally may range from 0.01-10 g/l.

Several structural features of one embodiment of photobioreactor unit 300 (which may be the same or similar to certain features of photobioreactor unit 200 of FIG. 2) will now be described, but it is important to note that the particular structural implementation of this embodiment are not intended to be limiting.

Base 310 of photobioreactor unit 300 in some embodiments may be formed of any wide variety of fluid impermeable materials. In one example of a non-floating photobioreactor unit configured for deployment on land, base 310 is formed of a compacted gravel base, and cover(s) 306 is supported by structural ribs 312. Structural ribs 312 may be attached to supports 314 embedded in trench sidewalls 316, which may be formed of the same material as the base. For embodiments where base 310 is not formed of a liquid impermeable material, a bottom liner 320 may be laid over or formed within the base 310 to provide a liquid impermeable surface (see, for example, FIG. 3B). Liner 320 may be, for example a plastic sheet, e.g., a polyethylene sheet, or any other suitable liner.

Cover(s) 306 may be constructed from a wide variety of transparent or translucent materials that are suitable for use in constructing a bioreactor. Some examples include, but are not limited to, a variety of transparent or translucent polymeric materials, such as polyethylenes, polypropylenes, polyethylene terephthalates, polyacrylates, polyvinylchlorides, polystyrenes, polycarbonates, etc. Alternatively, cover(s) 306 may be formed from glass or resin-supported fiberglass. In certain embodiments, cover(s) 306, in certain embodiments in combination with support elements such as support elements 312/314, is sufficiently rigid to be self-supporting and to withstand typical expected forces experienced during operation without collapse or substantial deformation. Portions of cover(s) 306 may be non-transparent in certain embodiments, and such portions can be made out of similar materials as described above for the at least partially transparent portions of cover(s) 306, except that, when they are desired to be non-transparent, such materials should be opaque or coated with a light-blocking material.

Cover(s) 306 may include a material which is stable to UV radiation and may, in certain embodiments be between about 4-6 mils in thickness, depending on the material. The material, in certain embodiments in combination with support elements such as support elements 312/314, may be designed to support external loads such as snow, wind and/or negatives pressures applied by an induced-draft fan. Additionally, in some embodiments, cover(s) 306 may be able to withstand internal pressure, such as when a forced-draft fan is used to push gas through photobioreactor unit 300.

Each section 330 may include a separate cover 306 with each cover 306 being connected to adjacent covers when the sections 330 are interconnected. In some embodiments, each section has a support element(s) 312/314 and a single piece of polyethylene or other suitable material is used to span multiple sections 330.

Each photobioreactor unit 300 may be formed with multiple photobioreactor sections 330 defined, in the illustrated embodiment, by separate cover sections 306. In this manner, constructing the designed length of the photobioreactor unit 300 may be achieved simply by selecting and interconnecting the appropriate number of photobioreactor sections 330. In some embodiments, the length of photobioreactor unit 300 may be changed and the rate of gas and/or liquid flow may be changed to accommodate long-term changes in treatment needs. Additionally, retrofitting photobioreactor unit 300 such as by increasing or decreasing the length may be possible.

While the photobioreactor unit embodiment shown in FIGS. 3A and 3B includes a trench 302 to create a liquid flow channel, in some embodiments, no trench may be present and the channel for a liquid stream may be formed at or above grade, e.g., as illustrated in the floating embodiment of FIG. 2. In certain embodiments, the base comprising the liquid flow channel may not be longitudinally continuous as illustrated, but may comprise a plurality of interconnected sections. For example, in certain embodiments, sections 330 may be defined by both a separate cover section and a separate base section in association with each other. The elevation of the photobioreactor unit may be substantially constant along the entire length of the channel or substantial portions thereof, and gravity flow of the liquid stream may be induced by adding liquid to a first end of the photobioreactor unit and allowing overflow (e.g., over a wall, weir, etc.) at the opposite end. In some embodiments, the photobioreactor unit may have a general, continuous downward pitch to promote liquid flow. In still other embodiments, abrupt elevation drops may be provided at the junctions of photobioreactor sections to create liquid flow and/or a cascading effect and/or to facilitate installation and operation over land areas with more substantial elevation changes.

Cover(s) 306 is shown as a semicircle or other curved surface in many of the embodiments disclosed herein, however, any suitable shape may be used, including a rectangular, triangular or trapezoidal shapes.

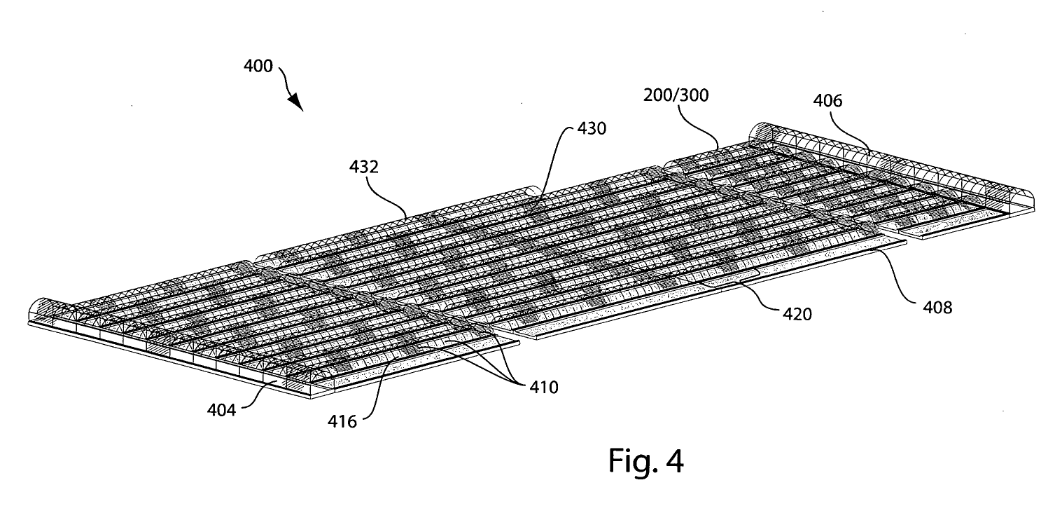

Referring now to FIG. 4, one embodiment of a large-scale photobioreactor system 400 is shown in perspective view. In this embodiment, the gas flows in the direction opposite to the liquid stream flow, however, in some embodiments, the gas may flow in the same direction as the liquid stream. Ten parallel photobioreactor units 200 and/or 300 are shown in the embodiment of FIG. 4, but fewer (including a single photobioreactor unit) or more photobioreactor units may be used. While photobioreactor units 200 and/or 300 as illustrated comprise straight, linear segments, in alternative embodiments, one or more of the photobioreactor units may be arcuate, serpentine, or otherwise non-linear, if desired. A liquid inlet/gas outlet bulkhead 404 runs perpendicular to the photobioreactor units at a first end of photobioreactor system 400. At an opposite end of photobioreactor system 400, a liquid outlet/gas inlet bulkhead 406 also runs perpendicular to the photobioreactor units 200 and/or 300. An optional rainwater drainage and vehicle access channel 408 runs parallel to the outer side of the overall photobioreactor system; however, the drainage and vehicle access channel 408 may be positioned between parallel photobioreactor units, or may not be present at all. In some embodiments, smaller rainwater drainage channels which do not accommodate vehicles may be provided.

The lengths of photobioreactor units 200 and/or 300 are selected to be sufficient, for a given desired liquid medium circulation rate, to provide sufficient gas-liquid contact time to provide a desired level of mass transfer between the gas and the liquid medium. Optimal contact time depends upon a variety of factors, especially the algal growth rate and carbon and nitrogen uptake rate as well as feed gas composition and flow rate and liquid medium flow rate. Scalability of the photobioreactor system 400 as a whole may be achieved, for example, by simply by adding additional photobioreactor units to the system, such as by adding photobioreactor units in a parallel relationship to existing photobioreactor units.

As described above, each photobioreactor unit 200 and/or 300 may include various zones having different functionality. One or more photobioreactor sections may be configured as a misting zone 416 to controllably add nutrients/media to the system and facilitate gas-liquid mass transfer. The nutrients and/or the medium in which the nutrients are carried may be provided in certain embodiments at least in part by recycling algae-depleted medium from a dewatering system. More than one nutrient misting section 416 may be provided. By employing a modular section-based construction, channel and/or cover sections which include misters may be added or removed after construction if so desired. In other embodiments, nutrients may be added by methods other than misting such as by direct pumping into the liquid stream. Unrecycled nutrients and/or medium (i.e., fresh make-up) also, or exclusively, may be used to supply the liquid stream in some embodiments.

Of course, in some embodiments, nutrients may be added using devices other than misters. For example, nutrients may flow from a pipe into the liquid medium stream, or nutrients may be showered from the top of the photobioreactor unit using a pipe with periodic openings.

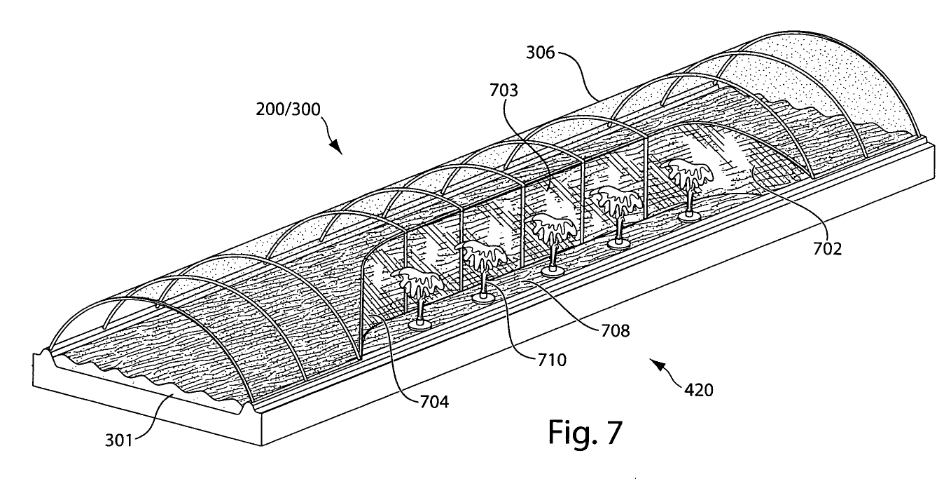

Each photobioreactor unit 200 and/or 300 may in certain embodiments include a cooling zone 420 comprising, in some cases, cooling sections 422. Cooling zone 420 may include portions in which the liquid stream is exposed to the atmosphere to provide for evaporative cooling. Examples of cooling zones are described in more detail below in reference to FIG. 7.

Harvesting algae, adjusting algal concentration, and introducing additional liquid medium can be facilitated via liquid medium inlet bulkhead 404 and liquid medium outlet bulkhead 406, e.g., as shown in FIG. 4. Control of the concentration of algae can be important from the standpoint of maintaining a desirable level of algal growth and proliferation. Algae may be harvested periodically or continuously from an end(s) of the photobioreactor units, or, in some embodiments, from one or more locations located between the ends of the photobioreactor units.

Various devices or mechanisms may, in certain embodiments, be included within photobioreactor units 200 and/or 300 to increase the interfacial surface area between the gas and the liquid medium to facilitate mass transfer. For example, sprayers that spray the liquid medium into the gas headspace may be used in certain embodiments. In some embodiments, liquid medium may be directed onto or over sheets of plastic or other suitable material such that the liquid medium travels down and/or over the surfaces of the sheets and falls back into the liquid stream. Alternatively or additionally, sheets of material which include pockets may periodically be dipped into the liquid stream and pulled upwardly into the gas headspace to increase the available liquid surface area. In certain embodiments, floating objects and/or devices configured to be partially submerged in the liquid medium (e.g., a paddle wheel) may be used to facilitate enhancement of gas-liquid interfacial area and mass transfer. In certain such embodiments, the objects may be transparent such that they also can act to allow penetration of light to greater depths within the media. In some embodiments, elements may be employed to produce surface ripples or even waves that travel laterally or longitudinally within the liquid medium to increase mass transfer between the gas and the liquid.

At least one or each photobioreactor unit 200 and/or 300 may, in certain embodiments, include one or more diversion zones or sections 430 which divert portions of the liquid streams to at least one reflow unit such as a reflow channel 432. For example, at least one channel section or zone of a photobioreactor unit may allow liquid to flow perpendicularly to the photobioreactor unit to reach reflow channel 432. The liquid in the reflow channel may then flow toward the liquid medium inlet bulkhead 404 and may be added to the liquid inflow by a pump (e.g., an Archimedes screw pump). By recirculating some of the liquid medium comprising phototrophic organisms therein, the addition of new innocula to the liquid medium at the front end of the photobioreactor unit may be reduced or eliminated in certain embodiments. In some embodiments, the recirculation rate may generally be in the range of 0.1-0.95, and in some particular embodiments, in the range of 0.5-0.7.

As would be apparent to those skilled in the art, particular configurations of the various photobioreactor units and components of the photobioreactor system will depend upon the particular use to which the photobioreactor is employed, the composition and quantity of the gas to be treated and other particular parameters specific to individual applications. Given the guidance provided herein and the knowledge and information available to those skilled in the arts of chemical engineering, biochemical engineering, and bioreactor design, one can readily select certain operating parameters and design configurations appropriate for a particular application, utilizing no more than a level of routine engineering and experimentation entailing no undue burden.

As discussed above in the description of FIG. 4, in certain embodiments, photobioreactor system 400 can comprise a plurality of identical or similar photobioreactor units 200 and/or 300 interconnected in parallel. Furthermore, in certain embodiments, at least one or each photobioreactor unit may comprise one photobioreactor section or a plurality of photobioreactor sections in series. Such scalability can provide flexibility to increase the capacity of the photobioreactor system and/or increase the degree of removal of particular components of the gas stream as a particular application or needs demand. In one such embodiment, a photobioreactor system is designed to separate algae species that are efficient in utilizing NOₓ from species efficient in utilizing CO₂. For example, a nitrogen-efficient algae is placed in a first photobioreactor unit or a first zone of a photobioreactor unit and carbon-efficient algae is placed in a second photobioreactor unit or in a second zone of the same photobioreactor unit in series with the first zone. The gas to be treated enters the first photobioreactor unit/zone and is scrubbed of nitrogen (from NOₓ), then flows through the second photobioreactor unit/zone and is scrubbed of carbon (from CO₂).

The term “fluidically interconnected”, when used in the context of conduits, channels, chambers, or other structures provided herein that are able to contain and/or transport gas and/or liquid, refers to such conduits, channels, containers, or other structures being of unitary construction or connected together, either directly or indirectly, so as to provide a continuous coherent flow path from one conduit or channel, etc. to the other(s) to which they are fluidically interconnected. In this context, two conduits or channels, etc. can be “fluidically interconnected” if there is, or can be established, liquid and/or gas flow through and between the conduits and/or channels (i.e., two conduits/channels are “fluidically interconnected” even if there exists a valve between the two conduits/channels that can be closed, when desired, to impede fluid flow there between).

A channel or trench may comprise, in certain embodiments, fluid impermeable wall(s) for partially or completely surrounding a fluid passing through the channel along its direction of flow. In other embodiments, wall(s) of a channel may only partially surround a fluid passing through the channel along its direction of flow and/or the wall(s) may have some degree of permeability with respect to a fluid flowing in the channel, so long as the wall(s) sufficiently surround the fluid and are fluid impermeable to a sufficient extent so as to be able to establish and maintain a bulk flow direction of fluid generally along a trajectory parallel to a longitudinal axis or curve defining the geometric center of the channel along its length.

The liquid medium contained within the photobioreactor system during operation typically comprises water or a saline solution (e.g., sea water or brackish water) containing sufficient nutrients to facilitate viability and growth of algae and/or other phototrophic organisms contained within the liquid medium. As discussed below, it is often advantageous to utilize a liquid medium comprising brackish water, sea water, or other non-potable water obtained from a locality in which the photobioreactor system will be operated and from which the algae contained therein was derived and/or to which the algae can be adapted. Particular liquid medium compositions, nutrients, etc. required or suitable for use in maintaining a growing algae or other phototrophic organism culture are well known in the art. Potentially, a wide variety of liquid media can be utilized in various forms for various embodiments of the present invention, as would be understood by those of ordinary skill in the art. Potentially appropriate liquid medium components and nutrients are, for example, discussed in detail in: Rogers, L. J. and Gallon J. R. “Biochemistry of the Algae and Cyanobacteria,” Clarendon Press Oxford, 1988; Burlew J. S. ed. “Algal Culture—From Laboratory to Pilot Plant, Carnegie Institution of Washington Publication 600, The Kirby Lithographic Co. Inc., Washington, D.C. (1961); Pulz O. and Scheibenbogen K. “Photobioreactors: Design and Performance with Respect to Light Energy Input,” Advances in Biochemical Engineering/Biotechnology, 59: pp. 124-151 (1998); and Round, F. E. The Biology of the Algae. St Martin's Press, New York, 1965; each incorporated herein by reference).

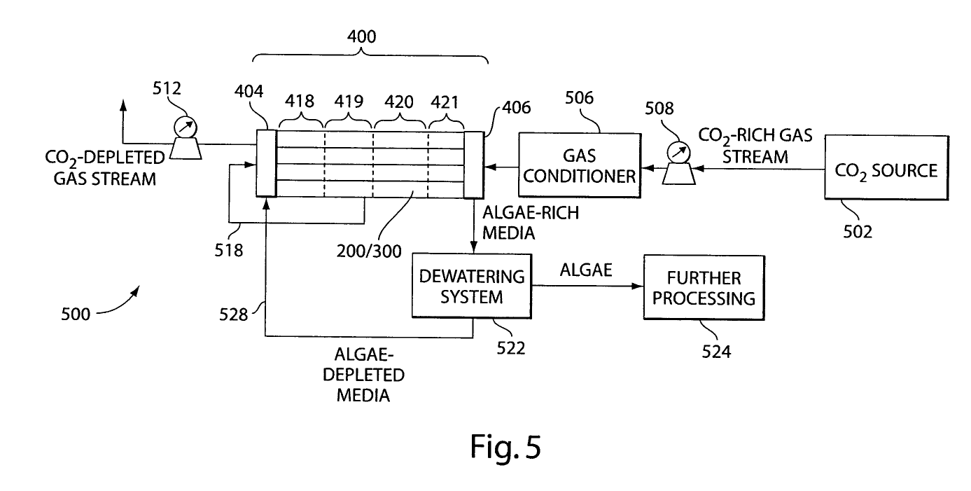

FIG. 5 schematically shows one embodiment of a gas treatment/biomass production/photobioreactor system 500 that uses solar energy and photobioreactor system 400 comprising photobioreactor units 200 and/or 300 to produce biomass using a gas to be treated, such as a byproduct gas stream produced by a facility associated with extracting and/or processing oil extracted from a mixture of oil and solid material containing elevated concentrations of carbon dioxide (i.e., gas having a concentration of carbon dioxide greater than ambient air). The gas to be treated is sent from a CO₂ source 502 to a gas conditioner 506, such as a conventional quench zone known to one of skill in the art, to reduce the gas temperature and possibly remove harmful species such as acid gases. In certain embodiments, a forced draft fan 508 may be used to facilitate this transfer of gas to be treated and/or push gas through photobioreactor units 200 and/or 300, but in some embodiments no forced draft fan is used. The gas is then sent through the photobioreactor units 200 and/or 300 so that the carbon dioxide (and potentially other gases) can interact with a liquid stream in the photobioreactor units to generate biomass. Photobioreactor system 400 may be constructed of one or more photobioreactor units 200 and/or 300 as described above. In the embodiment shown in FIG. 5, the gas is flowed countercurrently to the liquid stream; that is, the liquid stream flow from liquid inlet/gas outlet bulkhead 404 to liquid outlet/gas inlet 406. Make-up liquid medium (not shown) may be added during operation. In other embodiments, the flow of gas may be co-current with the liquid stream flow.

The photobioreactor units 200 and/or 300 may include different zones, e.g., 418, 419, 420, 421, along the lengths of the various photobioreactor units. In some embodiments, each photobioreactor unit may have similar zones, while in other embodiments, different zones and/or different zone locations may be provided in various of the photobioreactor units. For example, in a first zone 418, the bioreactor may include nutrient addition capabilities such as nutrient misting facilities. A second zone 419 may provide the option of diverting a portion of the liquid flow from the main photobioreactor units so that it may be returned to an upstream zone. Third zone 420 may include cooling capabilities such as evaporative cooling. A fourth zone 421 may be designed and/or controlled to environmentally stress algae, for example to increase lipids production. It should be noted that these particular zones are provided by way of example only, and as described further below, photobioreactor system 400 and/or individual photobioreactor units within photobioreactor system 400 may include fewer or more zones.

CO₂-depleted gas exits photobioreactor units 200 and/or 300 through liquid inlet/gas outlet bulkhead 404 and may be vented to the atmosphere or passed to further treatment options. An induced-draft fan 512 may be used to pull gas through the bioreactor, or, as described above, a forced-draft fan 508 may be used upstream of the photobioreactor units 200 and/or 300 instead of or in addition to the induced-draft fan in some embodiments. By using an induced-draft fan, the photobioreactor system and/or other portions of the overall system may be maintained at a negative pressure, thereby reducing the risk of unintentional venting of untreated gases to the atmosphere. Additionally, the use of an induced-draft fan (e.g., a blower), may simplify the integration of a photobioreactor system with waste gas producing facilities thereby reducing disruptions to operations. A blower is considered to be fluidically connected to a photobioreactor unit even if it is not directly connected to the photobioreactor unit; that is, other pieces of equipment or other conduits may be connected between the photobioreactor unit and the blower.

In certain embodiments, a portion of the liquid stream may be diverted, as shown by arrow 518, from a downstream zone of the photobioreactor units 200 and/or 300 and returned to an upstream zone (or in some embodiments to liquid inlet/gas outlet bulkhead 404) which may provide some of the benefits of a “back-mixed” reactor system. In this regard, the amount of inoculum added to the liquid in the photobioreactor units may be reduced or eliminated. Additionally, overall average residence time for the liquid medium may be increased without extending the length of the photobioreactor units. The diverted liquid medium may be returned at a position and in a manner such that the returned liquid medium causes or increases turbulence in the liquid stream, which may enhance heating or cooling and/or photomodulation in certain photobioreactor unit sections.

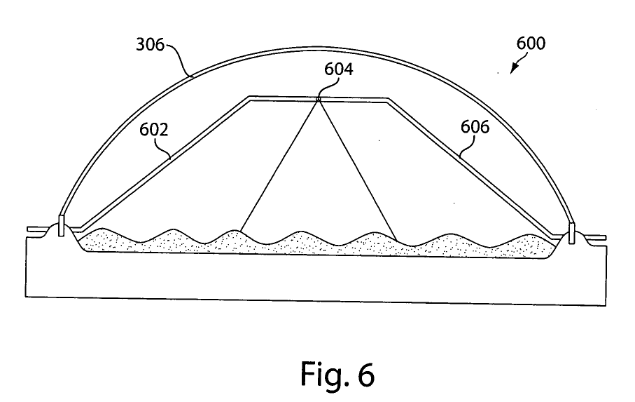

Referring now to FIG. 6, one embodiment of a nutrient/medium misting photobioreactor section or zone 600 is illustrated. A liquid inlet 602 may be formed of a conduit that also provides support for a mister 604. In some embodiments, liquid may flow into inlet 602 and all of the liquid may exit through mister 604. In some embodiments, liquid may flow through inlet 602 and some of the liquid may exit through mister 604 while the remaining liquid exits through an outlet 606 on the opposite side of section or zone 600 and continues to an adjacent photobioreactor unit. Mister 604 is shown as spraying liquid downwardly in FIG. 6, but in some embodiments the liquid may be aimed upwardly toward the inside of cover 306, such as directly upwardly. In this manner, mister 604 or other liquid injection device may help to clean the inside of cover 306 and the thin film of liquid formed on the inside surface of the cover can further enhance gas-liquid mass transfer.

While many of the embodiments described herein employ the movement of liquid through a gas headspace to promote mass transfer between the gas and liquid, in certain embodiments, additionally or alternatively, gas may be sparged into the liquid. For example, while the bulk of gas distribution into the liquid medium present in a photobioreactor unit 300 may be through a gas passageway such as the one shown in FIG. 3A, a not insignificant amount of gas may be sparged into the liquid medium in certain embodiments. The sparging, in addition to creating an additional gas-liquid interface, may create turbulence or additional turbulence in certain regions where such turbulence is desirable.

As mentioned above, in some embodiments, photobioreactors described herein include a cooling zone for cooling a liquid stream in the photobioreactor. FIG. 7 shows a perspective view of one example of a cooling zone 420 for a photobioreactor unit 200 and/or 300. In this embodiment, cover(s) 306 forms three walls 702, 703, and 704, which reduce the cross-sectional area of the gas headspace. Each wall 702, 703, and 704 penetrates into liquid stream 301 such that photobioreactor unit 200 and/or 300 remains gas-tight. In certain embodiments, however, walls 702, 703, and 704 do not reach the base of photobioreactor unit 200 and/or 300, such that the liquid stream may readily flow into evaporative cooling area 708. In some embodiments, sprayers 710 or other devices which increase surface area exposure of the liquid stream to the atmosphere may be employed to enhance evaporative cooling.

While evaporative cooling area 708 is shown to be present only on one side of the photobioreactor unit in this embodiment, a second evaporative cooling area may additionally (or instead) be provided on the opposite side of the photobioreactor unit, or positioned at an intermediate location positioned between the two laterally opposed sides of photobioreactor unit 200 and/or 300. For embodiments in which cooling zone 420 comprises one or more interconnectable photobioreactor sections, e.g., as with photobioreactor sections that include nutrient misters, the interchangeability of the photobioreactor sections may allow for the addition or subtraction of cooling areas after installation of the photobioreactor system.

In some embodiments, while flowing through photobioreactor unit 200 and/or 300, the liquid stream temporarily exits an enclosed portion of the photobioreactor unit and is exposed to the atmosphere. Evaporation of some of the liquid cools the remaining liquid, which can then reenter the enclosed portion of the photobioreactor unit. Each photobioreactor unit may be constructed and arranged such that the liquid stream does not significantly change direction or speed when exiting and reentering the enclosed portion of the photobioreactor unit. For example, as shown in the embodiment illustrated in FIG. 7, one or more photobioreactor sections of a photobioreactor unit may include walls that reduce the amount of cross-sectional area available for gas flow, but provide an area where the cover section(s) may be removed or indented to allow exposure of the liquid stream to the atmosphere.

In some embodiments of evaporative cooling zones, a portion of the liquid stream may be continuously exposed to the atmosphere; that is, within a relatively long zone of the photobioreactor unit, which may be made up of a large number of photobioreactor sections, the zone, or each section comprising such zone, may include an area (for example on the lateral side of the trench) that provides an evaporative cooling area. Substantially continuous mixing of the exposed portion of the liquid stream with the unexposed portion of the liquid stream may provide adequate cooling for the photobioreactor. As mentioned above, in certain embodiments, in addition to or as alternatives to photobioreactors of the type illustrated in FIGS. 2-7, as well as others described herein and in more detail in commonly-owned U.S. Provisional Patent Application No. 60/819,976, filed on Jul. 10, 2006, entitled, “Photobioreactor Systems and Methods for Treating CO₂-Enriched Gas and Producing Biomass,” by Lewnard et al and/or described in commonly-owned U.S. Patent Publication No. 2005/0260553, filed on Nov. 24, 2005, entitled, “Photobioreactor and Process for Biomass Production and Mitigation of Pollutants in Flue Gases”, by Berzin; and PCT Publication No. US2005/025249, filed on Jul. 18, 2005, entitled, “Photobioreactor and Process for Biomass Production and Mitigation of Pollutants in Flue Gases, by Berzin et al., bioreactors known in the art may be suitable for integration with oil sands or other oil extraction/processing operations in certain embodiments. Several such conventional designs are disclosed and described in detail in, for example, Burlew J. S. ed. “Algal Culture—From Laboratory to Pilot Plant, Carnegie Institution of Washington Publication 600, The Kirby Lithographic Co. Inc., Washington, D.C. (1961); Pulz O. and Scheibenbogen K. “Photobioreactors: Design and Performance with Respect to Light Energy Input,” Advances in Biochemical Engineering/Biotechnology, 59: pp. 124-151 (1998); and Richmond A. ed. “Handbook of Microalgal Culture—Biotechnology and Applied Phycology, Blackwell Publishing, Oxford, UK (2004). Representative open air systems for cultivation of algae are described, for example, in U.S. Pat. Nos. 3,650,068; 3,468,057; and 4,217,728. Raceway pond designs are discussed, for example, in Sheehan, et al (1998). Benemann and Oswald describe designs for ponds extending over thousands of hectares in “Systems and Economic Analysis of Microalgae Ponds for Conversion of CO₂ to Biomass” (1996) in their Final Report submitted to the Department of Energy, Pittsburgh Energy Technology Center under Grant No. DE-FG22-93PC93204. Certain conventional enclosed photobioreactor designs are disclosed, for example, in Mori (1986); U.S. Pat. No. 2,732,663; U.S. Pat. No. 6,827,036; U.S. Pat. No. 4,473,970; U.S. Pat. No. 5,541,056; U.S. Pat. No. 4,658,757; U.S. Pat. No. 4,868,123; 4,233,958; and U.S. Pat. No. 3,955,317; each of which is incorporated herein by reference.

Berzin and others have disclosed the use of closed bioreactors which also use submerged distributors, but control flow to regulate the exposure of algae to an optimal light/dark cycle. These bioreactors, which have increased productivity relative to some previous designs, in some cases require an external cooling fluid when operating in warm environments and high feed gas pressure for the submerged gas distributor. Additional examples of closed photobioreactors are described in detail in commonly-owned U.S. Patent Publication No. 2005/0260553, published on Nov. 24, 2005; and commonly-owned PCT Publication No. WO2006/020177, published on Feb. 23, 2006, both of which are incorporated herein by reference in their entirety.

As is apparent from the above description, integrated oil extraction/processing/photobioreactor gas treatment system 10 of FIG. 1 can provide a biotechnology-based air pollution control and renewable energy solution for oil sands and other oil extraction/processing facilities, such as those including heat and/or power generating facilities. The photobioreactor systems can comprise emissions control devices and regeneration systems that can remove gases and other pollutants, such as sulfur oxides, mercury, particulates, etc. deemed to be hazardous to people and the environment. Examples of such devices and systems are discussed commonly-owned PCT Publication No. WO2006/020177. Furthermore, the integrated photobioreactor/oil extraction/processing system can produce biomass that can be used as a source of renewable energy, thereby reducing the requirement of burning fossil fuels and/or cutting stock for, e.g., oil sands operations.

In certain embodiments, a photobioreactor system can be combined with one or more supplemental gas treatment apparatus in fluid communication with the photobioreactor system to effect removal of other typical gas contaminants produced during oil extraction, such as NOₓ, SOₓ, H₂S, CO, methane, and other volatile organic compounds. For example, in one embodiment, SOₓ precipitation and removal technologies can be installed in fluid communication with the photobioreactor, as described in more detail in commonly-owned PCT Application Serial No. PCT/US2006/037685, filed on Sep. 27, 2006, entitled, “Removal of Ash and Sulfur Dioxide in Flue Gas with a Combined Multifunction Impinging Stream of Gas-Liquid Reactor,” by Berzin et al., which is incorporated herein by reference in its entirety.

As described above, algae or other phototrophic organisms contained within the photobioreactor can utilize the CO₂ of a byproduct gas stream for growth and reproduction, thereby producing a biomass product. Nutrients may be added to optimize the growth rate of the organisms. In order to maintain optimal levels of algae or other phototrophic organisms within the photobioreactors, periodically a portion of the biomass, for example in the form of wet algae, can be removed from the photobioreactors through liquid medium outlet lines.

From there, the wet algae may be directed to dewatering system 60 for harvesting of the algae. In some embodiments, the dewatering system may use two stages of conventional processing. Primary dewatering can increase the algae concentration by a factor of, e.g., 10-30; secondary dewatering further increases the algal solids concentration to yield a cake suitable for downstream processing. The dewatering system may be fed with hot flue gas or other hot gas emissions streams, which may be utilized to vaporize at least a portion of the water component of the wet algae feed, thereby producing a dried algae biomass product, which is removed via a line (for more details regarding such process integration, see FIG. 11 and associated discussion of commonly-owned PCT Publication No. WO2006/020177). In certain embodiments, advantageously, the dewatering system, in addition to drying the algae and cooling the byproduct gas streams prior to injection in the photobioreactors, may also serve to humidify and/or quench the gas stream, thereby reducing the level of particulates and/or acids or other contaminates in the stream prior to introduction of the stream into the photobioreactor(s).

Various conventional methods and/or systems of dewatering may be used to dewater the algae, including dissolved air floatation and/or tangential flow filtration (discussed in more detail in U.S. Provisional Patent Application No. 60/819,976, filed on Jul. 10, 2006, entitled, “Photobioreactor Systems and Methods for Treating CO₂-Enriched Gas and Producing Biomass), or any other suitable dewatering approach. For instance, dissolved air floatation may involve mixing the algae feed with, e.g., aluminum sulfate, and contacted with bubbles generated by dissolving air into the filtrate that is recycled to the dewatering unit at an appropriate rate (e.g., 10%). The algal biomass may create a floc with a certain percentage (e.g., 4-5 wt %) of solids. Essentially algae-free filtrate may be recycled to the reactor, allowing unreacted nutrients to be returned to the system. Recycling this stream can reduce total water and nutrient requirements. Optionally, a portion or all of the dewatering feed stream can be contacted with a gas stream to be treated in the quench zone prior to dewatering. For gases containing acid gases such as SO₂, NOₓ, and HCl, absorption of the acid gases reduces pH from approximately 7-9 range to a more preferred range, e.g., 6.5-7.5. In this pH range, the quantity of aluminum sulfate required to dewater the algae is reduced. Tangential flow filtration may also be used for dewatering the algae. The filtration process may use a sterile-grade membrane and can operate at low trans-membrane pressures and low shear rates to increase the algae concentration, e.g., by a factor of 10-200. Cellular debris and bacterial contaminants can be concentrated with the algae-rich stream. The sterilized permeate stream may be recycled to the reactor, conserving water and nutrients while reducing risk due to recycle of deleterious species such as bacteria and cell lysates.

Water, or a portion thereof, removed from the dewatering steps can be returned to the photobioreactor, optionally with a small purge stream to prevent precipitation of salts. Make-up water can be added to maintain the media volume. In certain embodiments, water from holding ponds of an oil sands facilities can be used as or to make up media, optionally after treatment to remove particulates and/or contaminants.

The dried algae biomass recovered from dewatering system 60 can be utilized directly as a solid fuel for use in a combustion device of power plant 30 and/or may be converted into a fuel grade oil (e.g., biodiesel) in liquid biofuel processing unit 70. Alternatively or additionally, the biomass may be used for fuel gas production using conventional gasification technologies. The biomass can be decomposed in a pyrolysis or other known gasification process and/or a thermochemical liquefaction process to produce oil and/or combustible organic fuel gas from the biomass. Such methods of producing fuel grade oils and gases from algal biomass are well known in the art (e.g., see, Dote, Yutaka, “Recovery of liquid fuel from hydrocarbon rich microalgae by thermochemical liquefaction,” Fuel. 73: Number 12. (1994); Ben-Zion Ginzburg, “Liquid Fuel (Oil) From Halophilic Algae: A renewable Source of Non-Polluting Energy, Renewable Energy,” Vol. 3, No 2/3. pp. 249-252, (1993); Benemann, John R. and Oswald, William J., “Final report to the DOE: System and Economic Analysis of Microalgae Ponds for Conversion of CO₂ to Biomass.” DOE/PC/93204-T5, March 1996; and Sheehan et al., 1998; each incorporated by reference).

In certain embodiments, a photobioreactor system is combined and configured with a hydrogen generation system to generate hydrogen from biomass produced in and harvested from the photobioreactor, as described in more detail in commonly-owned U.S. Patent Publication No. 2005/0064577, which is incorporated herein by reference.

Once the liquid fuel is processed in liquid biofuel processing unit 70, at least a portion of it can be directed to pipeline pumping station 80, where the biofuel can be blended with at least a portion of the oil products produced by the oil sands facility (e.g., bitumen, petroleum diesel, synthetic crude, or other fuels). In some cases, the processed liquid fuel product serves as cutting stock for blending with and diluting bitumen so that the bitumen can be transported by pipelines. Blended products can be sent to a downstream processing facility 90, where the products are refined. Processing of the biomass may include, for example, extraction of vegetable oil and transesterification for production of biodiesel, fermentation of the biomass for production of ethanol, anaerobic digestion of the biomass for production of methane, gasification of the biomass for production of hydrogen and synthesis gas, and drying for production of solid biomass product.

The following examples are intended to illustrate certain embodiments of the present invention, but are not to be construed as limiting and do not exemplify the full scope of the invention.

### EXAMPLE 1

In this prophetic example, the trench photobioreactor of FIG. 2 or a plurality of such units interconnected in parallel is integrated with an oil sands facility according to the process described in FIG. 1. The CO₂-containing byproduct gas stream(s) emitted from a power plant and/or oil sands facility is routed to the photobioreactor to produce biomass product, which is then used to produce liquid fuel for generating electrical power and steam from a natural-gas combined-cycle power plant. The photobioreactor is deployed as a floating structure on the holding pond adjacent to the oil sands facility. The photobioreactor uses the algae species Nannochloris sp., which is grown in Media 1. Media 1 has the composition listed in Table 1.

TABLE 1
Algal Media 1, additives dispersed in Sea Water

| Component | Concentration (g/l) |
|---|---|
| NaNO₃ | 0.075 |
| NaH₂PO₄*2H₂O | 0.00565 |

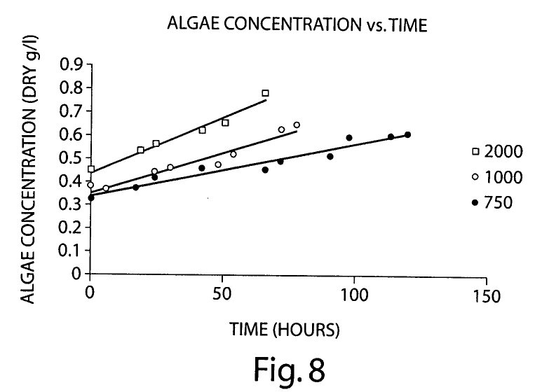

The predicted growth rates for the algae as a function of time, concentration, and light intensity, measured as photon flux, are derived from laboratory tests with well-stirred open tanks fed with gas containing 5 mol % CO₂, as well as O₂ and N₂ balanced in a 1:5 molar ratio. The test results are shown in FIG. 8 for insolation rates of 2000, 1000, and 750 μE/m²-s, and the productivities are tabulated in Table 2. As shown in FIG. 8, the productivity is not a function of concentration in this operating range. Independently, the growth rate can be predicted following the methods of Wu and Merchuk, (A Model Integrating Fluid Dynamics in Photosynthesis and Photoinhibition Processes. Chemical Engineering Science 56:3527-3538, 2001) to obtain model productivities. The parameter μₘₐₓ was averaged 0.077 hr⁻¹ in duplicate tests, and parameter kₓ is taken as 0.22 m²/g per Oswald (The Engineering Aspect of Microalgae. In: Laskin, I., and Lechevalier, H. A., Editors. CRC Handbook of Microbiology. Cleveland CRC Press. pp 519-552, 1977.) The model productivities match the measured productivities very well, as shown in Table 2.

TABLE 2

| | | Model Predicted |
|---|---|---|
| Light Intensity | Measured Productivity (dry | Productivity (dry weight |
| (μE/m²-s) | weight g/m²-hr) | g/m²-hr) |
| 2000 | 1.4 | 1.4 |
| 1000 | 1.1 | 1.1 |
| 750 | 0.7 | 0.9 |

A covered photobioreactor for use with the oil sands facility is modeled using the algal growth model discussed above and using the mass transfer rates from the laboratory tests. The photobioreactor has a depth of 20 cm and a liquid velocity of 20 cm/sec to ensure a high level of turbulence. The photobioreactor is sufficiently long that the flow is essentially plug flow; i.e., the Peclet number is high. The liquid phase comprises Media 1 maintained at pH 7.8 with an algae recycle rate selected to maintain the algae concentration in the feed end at 0.1 g cell dry weight/liter. The byproduct gas stream contains 5 mol % CO₂, and flows through channels with a gas freeboard height of 2 m. The photobioreactor is covered with polyethylene plastic film, with a measured visible light transmission of 95%. The media recycled from the dewatering system is split with 80% returned to the photobioreactor to enhance the CO₂ mass transfer rate by praying into the gas head space, and 20% sent to the open (i.e., uncovered) areas of the photobioreactor to generate a spray that enhances liquid cooling. The retention pond temperature is 20 degrees C., and the reactor temperature is also maintained at 20 degrees C. The reactor productivity, CO₂ conversion, power requirements for the flue gas handling and water consumption are listed in Table 3 for three levels of solar insolence.

TABLE 3
Comparison of Photobioreactor Performance at 30 degrees C. Ambient

| | | Reactor | CO₂ | Power | Water |
|---|---|---|---|---|---|
| | Light Intensity | productivity | conversion | requirement | Consumption |
| Example | (μE/m²-s) | (g/m²-hr) | (mol %) | (kW) | (kg/m²-hr) |
| Example 1 - | 2000 | 1.4 | 60% | 1 | 1.1 |
| Instant | | | | | |
| invention | | | | | |
| | 1000 | 1.1 | 50% | 1 | .5 |
| | 750 | 0.9 | 40% | 1 | .4 |

Algae from the photobioreactor of Example 1 is processed to extract algal oil. The algal oil is 23 wt % of the algal biomass, and the extraction efficiency is about 95%. The residual biomass contains approximately 50% carbohydrates, which can be fermented to ethyl alcohol at a conversion efficiency of 76 gal/metric ton bone dry algae. The ethanol from the fermentation process is reacted via transesterification with the algal oil to yield 63 gal biodiesel/metric ton bone dry algae. The biodiesel has a kinematic viscosity of 20×10⁻⁵ m²/s. The biodiesel is used as cutting fluid for the extracted oil from the oil sands facility, and sent to a refinery via the product pipeline. The biodiesel reduces the demand for cutting stock, and does not need to be reclaimed via distillation and returned to the oil sands facility.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An integrated oil processing and gas remediation method comprising acts of:
processing an oil extracted from a mixture of an oil and a solid material excavated from the earth to produce a processed oil product, wherein a byproduct gas stream is produced during the processing act;
passing at least a portion of the byproduct gas stream into an inlet of a photobioreactor system containing a liquid medium therein comprising at least one species of phototrophic organisms; and
at least partially removing at least one substance from the byproduct gas stream with the phototrophic organisms, the at least one substance being utilized by the organisms for growth and reproduction.

2. A method of claim 1, further comprising before the processing act, an act of extracting the oil from the mixture of an oil and a solid material excavated from the earth.

3. A method of claim 1, further comprising an act of removing at least a portion of the at least one species of phototrophic organisms from the photobioreactor system to form a biomass product.

4. A method of claim 3, further comprising an act of using at least a portion of the biomass product to produce liquid fuel product.

5. A method of claim 4, further comprising an act of using at least a portion of the liquid fuel product as cutting stock.

6. A method of claim 3, further comprising an act of using at least a portion of the biomass product and/or a fuel product derived from the biomass as fuel for a furnace and/or electrical power generating system.

7. A method of claim 1, wherein CO₂ is removed from the byproduct gas stream during the at least partially removing act.

8. A method of claim 1, wherein NOₓ is removed from the byproduct gas stream during the at least partially removing act.

9. An integrated oil production and gas treatment system comprising:
an oil extraction and processing facility configured to extract oil from a mixture of an oil and a solid material excavated from the earth and to process extracted oil to produce a processed oil product, wherein the facility comprises at least one gas outlet from which is emitted a byproduct gas stream; and
a photobioreactor system containing a liquid medium comprising at least one species of phototrophic organisms, at least a portion of the photobioreactor system being configured to transmit light to the phototrophic organisms, the photobioreactor system comprising an inlet connected in fluid communication with at least one gas outlet of the facility, the photobioreactor system further comprising an outlet configured to release treated gas from the photobioreactor system.

10. A system of claim 9, wherein the oil extraction and processing facility further comprises a heat and/or power generating system configured to provide heat and/or power to facilitate at least one of oil extraction and processing of extracted oil, wherein the heat and/or power generating system comprises at least one gas outlet from which is emitted a byproduct gas stream, and wherein at least one gas outlet of the heat and/or power generating system is connected in fluid communication with the inlet of the photobioreactor system.

11. A system of claim 9, wherein the oil extraction and processing facility is an oil sands extraction and processing facility.

12. A method of claim 11, wherein the oil sands extraction and processing facility is a surface mining facility.

13. A method of claim 9, wherein the mixture comprises bitumen.

14. A method of claim 9, wherein the photobioreactor is constructed and arranged to float on a holding pond associated with the oil extraction and processing facility.

15. A method of claim 14, wherein at least one source of waste heat produced by the facility is in heat transfer communication with the pond so as to utilize the pond as a waste heat sink, thereby heating the water in the pond.

16. A method of claim 9, wherein the oil extraction and processing facility comprises a catalytic reforming and/or water-gas-shift reactor.

17. A method of claim 9, wherein the oil extraction and processing facility comprises a catalytic oil hydrogenation reactor.

18. A method of claim 9, wherein the oil extraction and processing facility comprises a coking reactor.

19. A method of claim 9, wherein the photobioreactor system comprises a plurality of interconnectable photobioreactor sections which, when connected together, form at least one longitudinally-oriented photobioreactor unit of the photobioreactor system, the photobioreactor sections each comprising a liquid flow channel and a light-transparent cover that forms a gas headspace between the cover and the liquid flow channel;
wherein the cover is constructed and arranged to cover at least a substantial portion of the liquid flow channel and is configured to be capable of providing the gas headspace even when a gas pressure within the photobioreactor unit is less than the atmospheric pressure surrounding the photobioreactor section.

20. A method of claim 9, wherein the photobioreactor system comprises at least one photobioreactor section constructed and arranged to carry a flow of liquid medium comprising phototrophic organisms therein; the photobioreactor section comprising:
a cover constructed and arranged to cover at least a substantial portion of the liquid medium within the photobioreactor section and further constructed and arranged to provide a gas headspace under the cover and above the liquid medium, the cover being capable of providing the gas headspace even when a gas pressure within the photobioreactor is less than the atmospheric pressure surrounding the photobioreactor section;
a liquid inlet to provide liquid medium to the photobioreactor section;
a liquid outlet from which to remove liquid medium comprising phototrophic organisms therein from the photobioreactor section;
a gas inlet to provide gas containing an elevated concentration of carbon dioxide into the gas headspace;
a gas outlet from which to remove gas containing carbon dioxide at a concentration less than at the gas inlet; and
a blower fluidically connected to the gas outlet able to create a flow of gas through the gas headspace from the gas inlet to the gas outlet.

21. A method of claim 9, wherein the photobioreactor system comprises at least one longitudinally extending photobioreactor unit comprising at least one photobioreactor section, the photobioreactor unit being constructed and arranged to carry a flow of liquid medium comprising phototrophic organisms therein; the photobioreactor unit comprising:
at least one cover constructed and arranged to cover at least a substantial portion of the liquid medium within the photobioreactor unit and constructed and arranged to provide a gas headspace under the cover and above the liquid medium, the cover being capable of providing the gas headspace even when a gas pressure within the gas headspace of the photobioreactor is less than the atmospheric pressure surrounding the photobioreactor unit;
a first liquid inlet constructed and arranged to provide a liquid medium to the photobioreactor unit;
a first liquid outlet from which the liquid medium is removable from the photobioreactor unit;
a second liquid outlet positioned between the first liquid inlet and the first liquid outlet, from which the liquid medium is removable from the photobioreactor unit; and
a channel fluidically interconnecting the second liquid outlet to the photobioreactor unit at a position which is upstream of the second liquid outlet to enable return and recycle of the liquid medium within the photobioreactor unit.

22. A method of claim 9, wherein the photobioreactor system comprises at least one photobioreactor section constructed and arranged to carry a flow of liquid medium comprising phototrophic organisms therein; the photobioreactor section comprising:
a cover constructed and arranged to cover at least a substantial portion of the liquid medium within the photobioreactor section and constructed and arranged to provide a gas headspace under the cover and above the liquid medium, the gas headspace being maintainable at a pressure that differs from atmospheric pressure;
a liquid inlet configured to provide liquid medium to the photobioreactor section;
a liquid outlet from which liquid medium is removable from the photobioreactor section; and
a gas outlet from which gas containing carbon dioxide at a concentration less than at the gas inlet is removable from the photobioreactor section; wherein
the photobioreactor section comprises a first portion of the photobioreactor section in which the cover provides the gas headspace over a first portion of the liquid medium, and further comprises a second, different portion of the photobioreactor section in which a second portion of the liquid medium is exposed to gas outside of the gas headspace to facilitate evaporative cooling of the liquid medium.

23. A method of claim 9, wherein the photobioreactor system comprises at least one photobioreactor section constructed and arranged to carry a flow of liquid medium comprising phototrophic organisms therein and a flow of gas containing an elevated concentration of carbon dioxide; the photobioreactor section comprising:
a liquid inlet constructed and arranged to provide at least liquid medium to the photobioreactor section;
a liquid outlet from which liquid medium is removable from the photobioreactor section;
a gas inlet constructed and arranged to provide gas containing an elevated concentration of carbon dioxide to the photobioreactor section;
a gas outlet from which gas containing carbon dioxide at a concentration less than at the gas inlet is removable from the photobioreactor section;
a cover constructed and arranged to cover at least a substantial portion of the flow of liquid medium within the photobioreactor section and constructed and arranged to provide a gas headspace under the cover and above the liquid medium;
wherein the photobioreactor section includes a portion of the photobioreactor section where the liquid medium is exposed to gas outside of the gas headspace to facilitate evaporative cooling of the liquid medium, and
wherein the photobioreactor system comprises a controller configured to control the amount of evaporative cooling of the liquid medium in the portion of the photobioreactor section where the liquid medium is exposed to gas outside of the gas headspace.

24. A method of producing biomass comprising acts of:
providing a liquid medium comprising at least one species of phototrophic organisms within a photobioreactor system;
exposing at least a portion of the photobioreactor system and the at least one species of phototrophic organisms to a source of light capable of driving photosynthesis;
introducing a byproduct gas stream derived at least in part from an oil extraction and processing facility configured to extract oil from a mixture of an oil and a solid material excavated from the earth and to process extracted oil to produce a processed oil product, and/or introducing a byproduct gas stream derived from a furnace and/or electrical power generating system associated with the oil extraction and processing facility, to an inlet of the photobioreactor system; and
harvesting at least a portion of the phototrophic organisms from the photobioreactor system to form biomass.

25. A method of claim 24, further comprising an act of generating a liquid fuel product from the biomass.

26. A method of claim 24, wherein the oil extraction and processing facility comprises an oil sands facility.

27. A method of claim 26, wherein the oil sands facility is a surface mining facility.

28. A method of claim 24, wherein the mixture comprises bitumen.

29. A method of claim 24, wherein the photobioreactor is constructed and arranged to float on a holding pond associated with the oil extraction and processing facility.

30. A method of claim 24, wherein heat from the holding pond is used to maintain a temperature within the photobioreactor.

31. A method of claim 24, further comprising drying the biomass.

32. A method of claim 24, wherein the byproduct gas stream comprises CO₂ and/or NOₓ.

33. A method of claim 24, wherein the byproduct gas stream is produced during processing of oil extracted from a mixture of an oil and a solid material excavated from the earth.

34. A method of claim 33, wherein the byproduct gas stream comprises a reaction product emitted from a catalytic reforming and/or water-gas-shift reactor of a system used to process the oil extracted from a mixture of an oil and a solid material excavated from the earth to produce the processed oil product.

35. A method of claim 34, wherein the system used to process the oil extracted from a mixture of an oil and a solid material excavated from the earth to produce the processed oil product further comprises a catalytic oil hydrogenation reactor.

36. A method of claim 24, wherein the byproduct gas stream comprises combustion gas produced by a furnace and/or electrical power generating system.

37. A method of claim 36, wherein the furnace and/or electrical power generating system is used to provide thermal energy to a coking reactor used to process the oil extracted from a mixture of an oil and a solid material excavated from the earth to produce the processed oil product.

38. A method of claim 24, comprising at least partially removing CO₂ and/or NO, from the byproduct gas stream with the photobioreactor.

39. A method as in claim 24, wherein the at least one species of phototrophic organisms within the photobioreactor comprises algae.

40. A method as in claim 24, wherein the source of light capable of driving photosynthesis comprises the sun.

41. A method as in claim 25, further comprising an act of blending at least a portion of the liquid fuel product derived from the biomass with at least a portion of the processed oil product produced from the oil extraction and processing facility.

42. A method as in claim 24, further comprising an act of using at least a portion of the liquid fuel product derived from the biomass as fuel for the furnace and/or electrical power generating system.
